(19) United States
(12) Patent Application Publication
(10) Pub. No.: US 2026/0119999 A1
(43) Pub. Date: Apr. 30, 2026

(54) SHALLOW AND DEEP LEARNING MODELS FOR DETERMINING TARGET LIKELIHOODS

(71) Applicant: Dell Products L.P., Round Rock, TX (US)

(72) Inventors: Bijan MOHANTY, Austin, TX (US); Manoj NAMBIRAJAN, Hyderabad (IN); Mohit Kumar AGARWAL, Cyberjaya (MY); Hung DINH, Austin, TX (US)

(21) Appl. No.: 18/930,605

(22) Filed: Oct. 29, 2024

(51) Int. Cl. G06N 20/20

(52) U.S. Cl. CPC G06N 20/20

(57) ABSTRACT

In some implementations, a model system may train a deep learning model to determine baseline figures and stretch figures and may train a shallow learning model to determine likelihoods associated with achieving the baseline figures and the stretch figures. The model system may receive indicators associated with a current entity and may provide the indicators to the deep learning model to generate a baseline figure and a stretch figure. The model system may receive progress data associated with the current entity. The model system may provide output based on the deep learning model and the progress data to the shallow learning model to generate a likelihood associated with the current entity achieving at least one of the baseline figure or the stretch figure. The model system may selectively provide an alert to a user based on the likelihood.

### BACKGROUND

In predicting goals or outcomes, neural networks may provide increased accuracy as compared with other machine learning models. However, neural networks consume significant computing resources to train and apply.

### SUMMARY

Some implementations described herein relate to a device for applying a deep learning model and a shallow learning model to determine likelihoods of achieving targets. The device may include one or more processors. The one or more processors may be configured to receive historical data associated with a set of training entities. The one or more processors may be configured to train the deep learning model using indicators included in the historical data to determine baseline figures and stretch figures associated with the set of training entities. The one or more processors may be configured to train the shallow learning model using progress data included in the historical data to determine likelihoods associated with achieving the baseline figures and the stretch figures. The one or more processors may be configured to receive indicators associated with a current entity. The one or more processors may be configured to provide the indicators associated with the current entity to the deep learning model to generate a baseline figure and a stretch figure for the current entity. The one or more processors may be configured to receive progress data associated with the current entity and at least one of the baseline figure or the stretch figure. The one or more processors may be configured to provide output based on the deep learning model and the progress data associated with the current entity to the shallow learning model to generate a likelihood associated with the current entity achieving at least one of the baseline figure or the stretch figure. The one or more processors may be configured to selectively provide an alert to a user based on the likelihood.

Some implementations described herein relate to a method for applying a deep learning model and a shallow learning model to determine likelihoods of achieving targets. The method may include receiving, by a model system, historical data associated with a set of training entities. The method may include training, by the model system, the deep learning model using indicators included in the historical data to determine baseline figures and stretch figures associated with the set of training entities. The method may include training, by the model system, the shallow learning model using progress data included in the historical data to determine likelihoods associated with achieving the baseline figures and the stretch figures. The method may include receiving, by the model system, indicators associated with a current entity. The method may include providing, by the model system, the indicators associated with the current entity to the deep learning model to generate a baseline figure and a stretch figure for the current entity. The method may include receiving, by the model system, progress data associated with the current entity and at least one of the baseline figure or the stretch figure. The method may include providing, by the model system, output based on the deep learning model and the progress data associated with the current entity to the shallow learning model to generate a likelihood associated with the current entity achieving at least one of the baseline figure or the stretch figure. The method may include selectively providing, by the model system, an alert to a user based on the likelihood.

Some implementations described herein relate to a non-transitory computer-readable medium that stores a set of instructions. The set of instructions, when executed by one or more processors of a model system, may cause the model system to receive historical data associated with a set of training entities. The set of instructions, when executed by one or more processors of the model system, may cause the model system to train a deep learning model using indicators included in the historical data to determine baseline figures and stretch figures associated with the set of training entities. The set of instructions, when executed by one or more processors of the model system, may cause the model system to train a shallow learning model using progress data included in the historical data to determine likelihoods associated with achieving the baseline figures and the stretch figures. The set of instructions, when executed by one or more processors of the model system, may cause the model system to receive indicators associated with a current entity. The set of instructions, when executed by one or more processors of the model system, may cause the model system to provide the indicators associated with the current entity to the deep learning model to generate a baseline figure and a stretch figure for the current entity. The set of instructions, when executed by one or more processors of the model system, may cause the model system to receive progress data associated with the current entity and at least one of the baseline figure or the stretch figure. The set of instructions, when executed by one or more processors of the model system, may cause the model system to provide output based on the deep learning model and the progress data associated with the current entity to the shallow learning model to generate a likelihood associated with the current entity achieving at least one of the baseline figure or the stretch figure. The set of instructions, when executed by one or more processors of the model system, may cause the model system to selectively provide an alert to a user based on the likelihood.

### BRIEF DESCRIPTION OF THE DRAWINGS

FIGS. 1A-1E are diagrams of an example implementation relating to shallow and deep learning models for determining target likelihoods, in accordance with some embodiments of the present disclosure.

FIGS. 2A-2B are diagrams illustrating an example of training and using a machine learning model in connection with systems and/or methods described herein, in accordance with some embodiments of the present disclosure.

FIG. 3 is a diagram of an example associated with a deep learning model, in accordance with some embodiments of the present disclosure.

FIG. 4 is a diagram of an example environment in which systems and/or methods described herein may be implemented, in accordance with some embodiments of the present disclosure.

FIG. 5 is a diagram of example components of one or more devices of FIG. 4, in accordance with some embodiments of the present disclosure.

FIG. 6 is a flowchart of an example process relating to using shallow and deep learning models for determining target likelihoods, in accordance with some embodiments of the present disclosure.

### DETAILED DESCRIPTION

The following detailed description of example implementations refers to the accompanying drawings. The same reference numbers in different drawings may identify the same or similar elements.

Generally, neural networks may provide increased accuracy as compared with other machine learning models. However, neural networks consume significant computing resources to train and apply. Additionally, when multiple outputs are requested (e.g., a goal for a user as well as a likelihood of achieving the goal based on a current progress of the user), multiple neural networks may be deployed, further increasing computing costs.

Combining a deep learning model (e.g., a neural network) with a shallow learning model (e.g., a random forest classifier) conserves computing costs, as compared with training and using two neural networks. As used herein, “deep learning” may refer to a neural network with more than one hidden layer, while “shallow learning” may refer to a random forest model or another non-neural-network model. Some implementations described herein enable a deep learning model to predict baseline and stretch goals and a shallow learning model to predict a likelihood of achieving a baseline goal or a stretch goal from the deep learning model. As a result, computing resources are saved, as compared with using multiple deep learning models. Additionally, accuracy of the baseline and stretch goals is improved by using the deep learning model, which conserves resources that otherwise would have been wasted on planning around, and attempting to achieve, inaccurate goals.

Some implementations additionally provide for automatic alerts based on likelihoods from the shallow learning model. For example, the automatic alerts may include a suggested change based on varying inputs to the shallow learning model. Because the automatic alerts are selective (e.g., only for users associated with likelihoods that satisfy a threshold), network and computing resources are conserved, as compared with providing alerts to all users.

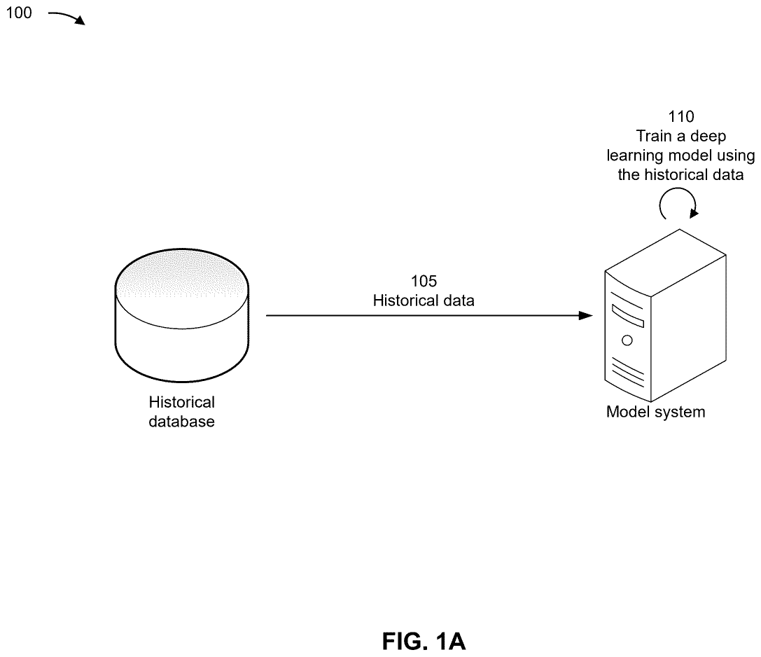

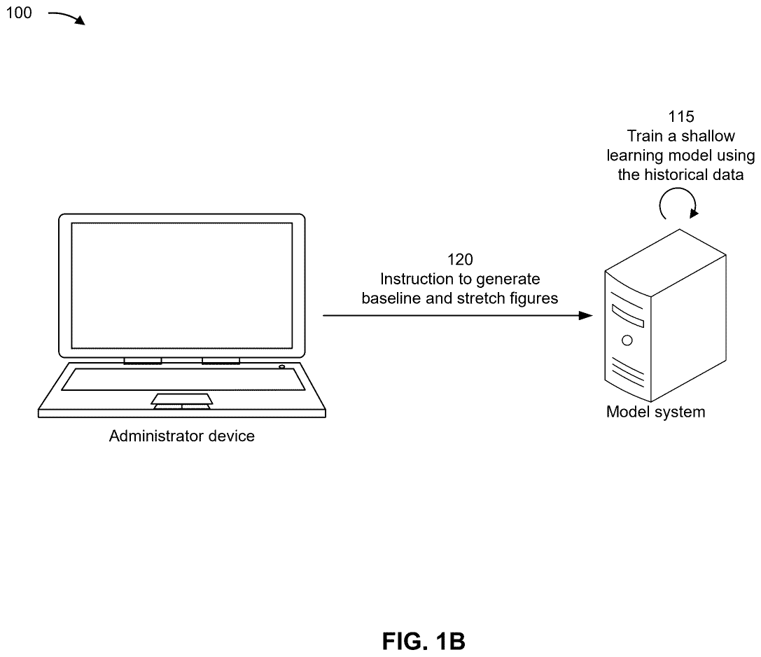

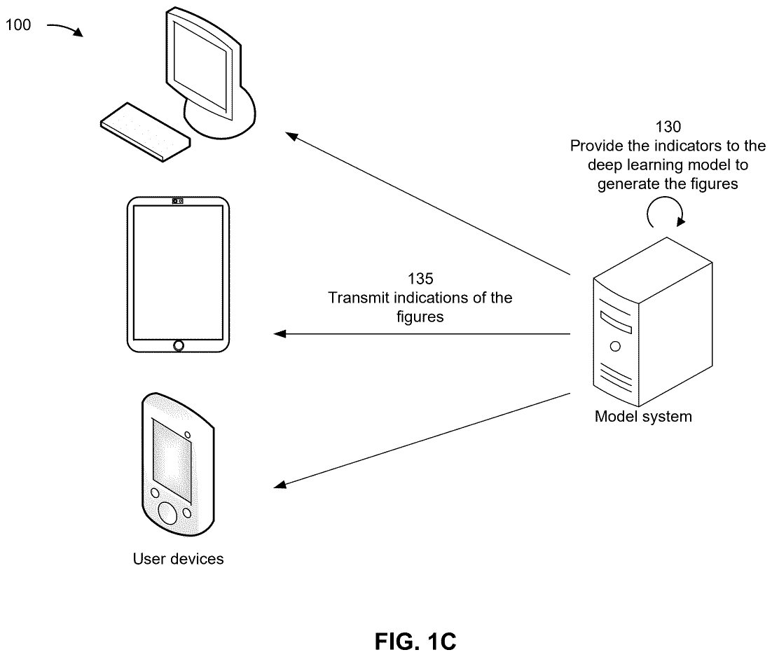

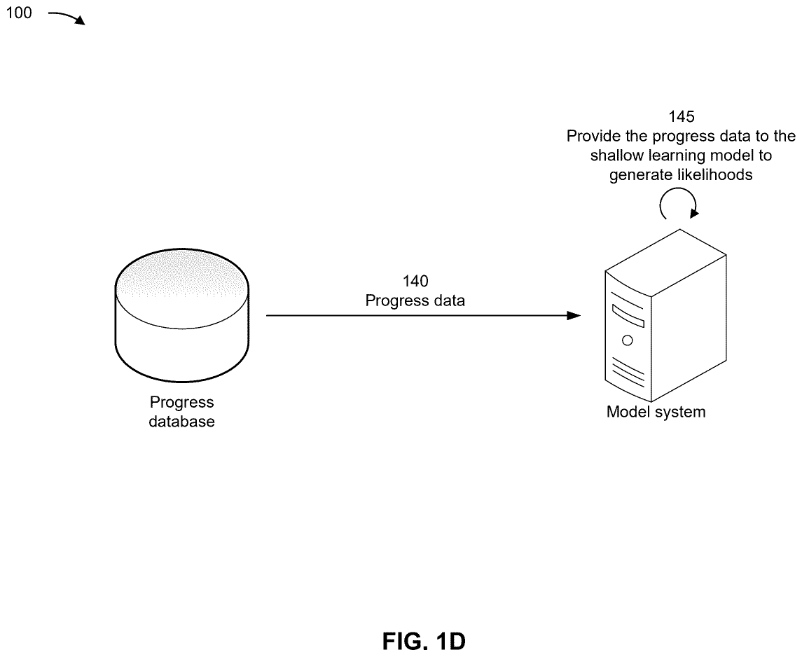

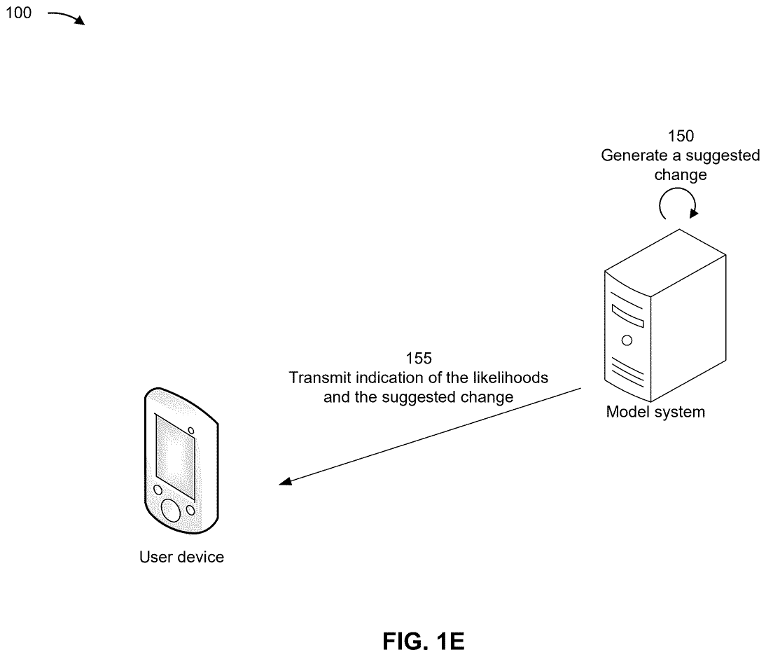

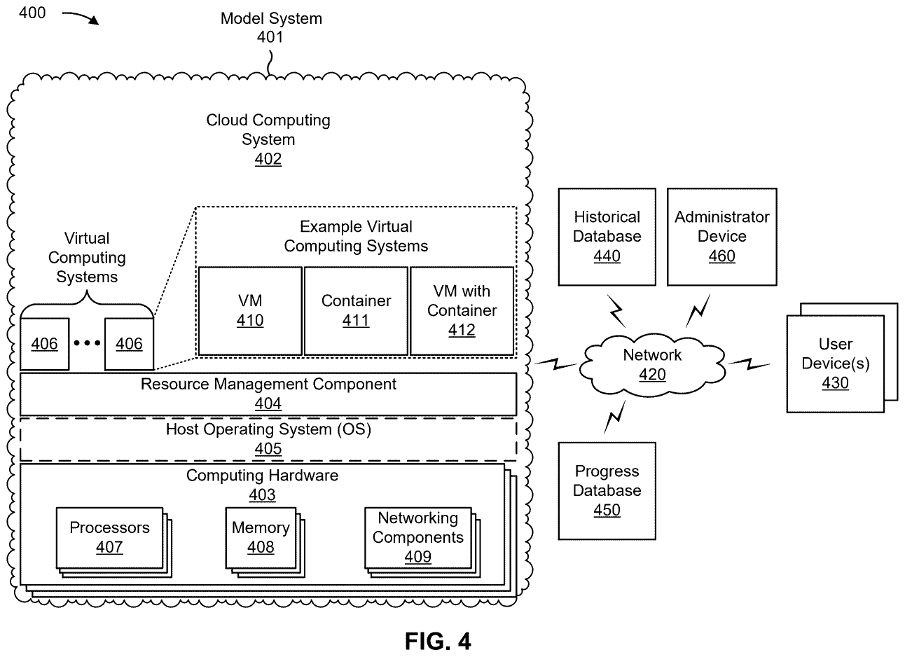

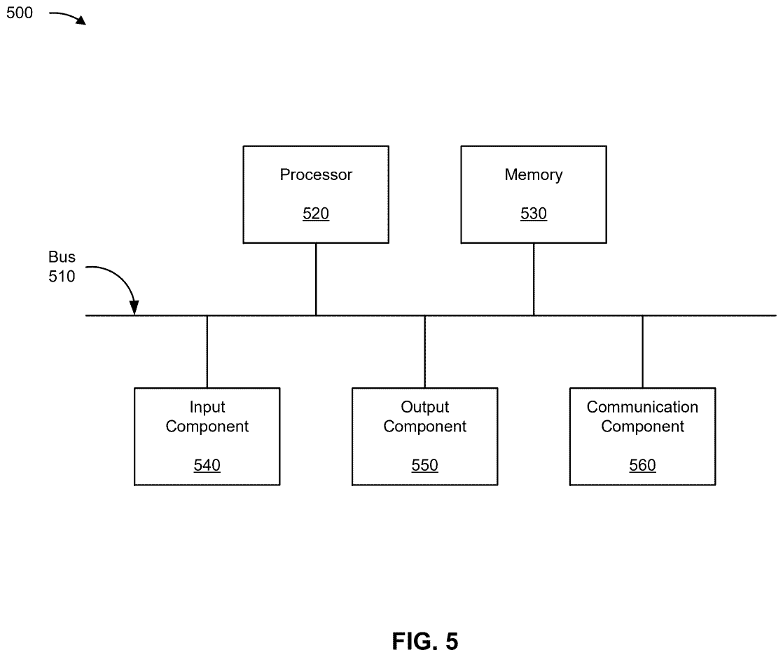

FIGS. 1A-1E are diagrams of an example 100 associated with shallow and deep learning models for determining target likelihoods. As shown in FIGS. 1A-1E, example 100 includes a set of user devices, a historical database, a progress database, and an administrator device. These devices are described in more detail in connection with FIGS. 4 and 5.

As shown in FIG. 1A and by reference number 105, the historical database may transmit, and the model system may receive, historical data associated with a set of training entities. For example, the historical data may include past performances along with associated properties (e.g., categories and/or regions, among other examples). Accordingly, the set of training entities may include persons associated with the past performances. The historical data may be encoded in a tabular data format or another type of relational data format (e.g., searchable with structured query language (SQL) queries), or in a NoSQL data format.

In some implementations, the model system may transmit, and the historical database may receive, a request for the historical data. Accordingly, the historical database may transmit, and the model system may receive, the historical data in response to the request. The model system may transmit the request periodically (e.g., according to a schedule) or in response to input (e.g., from the administrator device). Rather than the model system pulling the historical data, the historical database may push the historical data to the model system. For example, the model system may subscribe to updates from the historical database, such that the historical database transmits new historical data when available (e.g., upon creation).

In some implementations, the model system may preprocess the historical data by normalizing the indicators included in the historical data. For example, the past performances may be standardized between 0.0 and 1.0, to improve accuracy of training a deep learning model, as described below.

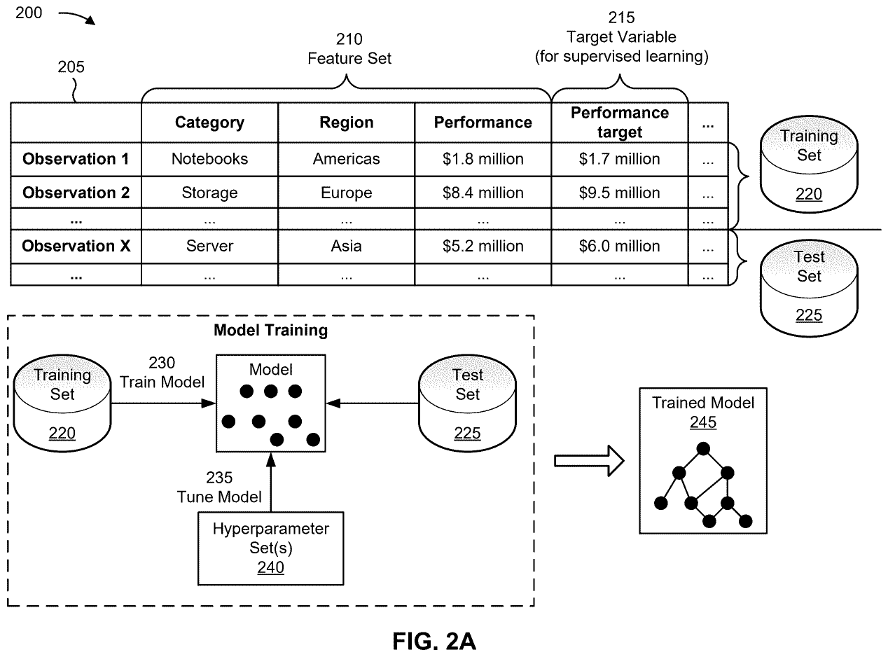

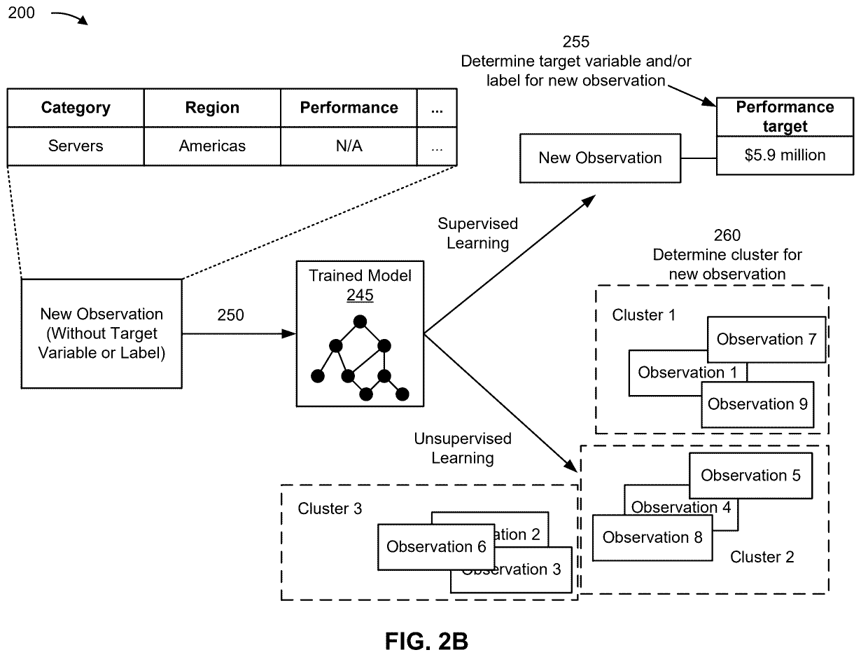

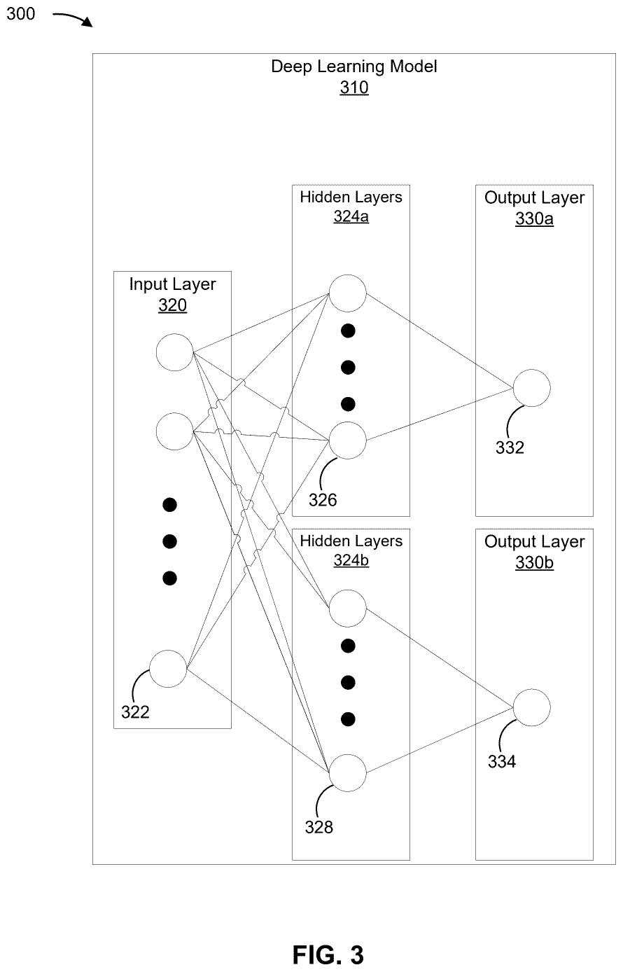

As shown by reference number 110, the model system may train a deep learning model, using indicators included in the historical data, to determine baseline figures and stretch figures associated with the set of training entities. For example, the model system may train the deep learning model as described in connection with FIG. 2A. The deep learning model may be a multi-output model configured to output the baseline figure and stretch figure concurrently, as described in connection with FIG. 3.

In some implementations, the model system may apply a feature selection algorithm to identify the most predictive indicators from the historical data. For example, the model system may discard features in the historical data that fail to satisfy a relevance threshold (e.g., based on regression) in order to reduce computing resources consumed by the deep learning model. The model system may use the most predictive indicators to train the deep learning model.

As shown in FIG. 1B and by reference number 115, the model system may train a shallow learning model, using progress data included in the historical data, to determine likelihoods associated with achieving the baseline figures and the stretch figures. The progress data may include quarterly progress, monthly progress, or another type of data representing partial achievement of performance targets indicated in the historical data. In some implementations, the model system may train the shallow learning model as described in connection with FIG. 2A. The shallow learning model may include a classification model. Training and using the shallow learning model may conserve computing resources as compared with training another deep learning model.

As shown by reference number 120, the administrator device may transmit, and the model system may receive, an instruction to generate baseline and stretch figures for one or more current entities. The one or more current entities may include persons to receive the baseline and stretch figures. In some implementations, an administrator using the administrator device may provide input (e.g., via an input component) that triggers the administrator device to transmit the instruction. Alternatively, the model system may automatically initiate generation of the baseline and stretch figures (e.g., according to a schedule).

As shown in FIG. 1C and by reference number 130, the model system may provide indicators, associated with the one or more current entities, to the deep learning model to generate a baseline figure and a stretch figure for each current entity. For example, the indicators may include categories, regions, and/or other indicators identified by the feature selection algorithm. Accordingly, the deep learning model may output the baseline figure and the stretch figure for a current entity based on the indicators associated with the current entity. As described in connection with FIG. 3, latency is reduced in generating both figures because the deep learning model may output the baseline figure for a current entity concurrently with a stretch figure for the current entity.

The model system may provide indications of the baseline figures and the stretch figures to the one or more current entities. For example, as shown by reference number 135, the model system may transmit, and the set of user devices associated with the one or more current entities may receive, the indications. The indications may be included in text messages, email messages, and/or push notifications, among other examples.

As shown in FIG. 1D and by reference number 140, the progress database may transmit, and the model system may receive, progress data associated with the one or more current entities. For example, the progress data may include quarterly progress, monthly progress, or another type of data representing partial achievement of the baseline figures and the stretch figures by the one or more current entities. The progress data may be encoded in a tabular data format or another type of relational data format (e.g., searchable with SQL queries), or in a NoSQL data format.

In some implementations, the model system may transmit, and the progress database may receive, a request for the progress data. Accordingly, the progress database may transmit, and the model system may receive, the progress data in response to the request. The model system may transmit the request periodically (e.g., according to a schedule) or in response to input (e.g., from the administrator device). Rather than the model system pulling the progress data, the progress database may push the progress data to the model system. For example, the model system may subscribe to updates from the progress database, such that the progress database transmits new progress data when available (e.g., upon creation).

As shown by reference number 145, the model system may provide the progress data, along with at least one of the baseline figures or the stretch figures, to the shallow learning model to generate one or more likelihoods associated with the one or more current entities achieving at least one of the baseline figures or the stretch figures. In some implementations, the model system may provide the baseline figures and/or the stretch figures directly as output based on the deep learning model. As a result, the model system may conserve network resources that otherwise would have been expended on receiving the baseline figures and/or the stretch figures (e.g., from the administrator device or the progress database).

The shallow learning model may output the likelihood(s) for the one or more current entities based on the progress data. The shallow learning model consumes fewer computing resources when running than the deep learning model.

The model system may determine, for one of the current entities, that the likelihood for the current entity satisfies a failure threshold. The failure threshold may be preconfigured, set by the administrator device, or set by the current entity (e.g., via a user device of the current entity). Accordingly, as shown in FIG. 1E and by reference number 150, the model system may generate a suggested change for the current entity by varying at least one input to the shallow learning model. For example, the model system may recommend an increase in performance in a subsequent quarter or month by the current entity in order to increase the likelihood of meeting the baseline figure and/or the stretch figure. In some implementations, the model system may use an indicator associated with the current entity (e.g., a category or a region) to determine the suggested change (e.g., using a dictionary of strategies or another data structure mapping indicators to suggested changes). The model system may generate the suggested change in response to the likelihood satisfying the failure threshold.

The model system may selectively provide an indication of the likelihood, and any suggested change, based on the likelihood. For example, as shown by reference number 155, the model system may transmit, and a user device associated with the current entity may receive, the indication. The indication may be included in a text message, an email message, and/or a push notification, among other examples. Selectively providing alerts based on the failure threshold conserves network resources and computing resources as compared with providing alerts to all current entities.

As indicated above, FIGS. 1A-1E are provided as an example. Other examples may differ from what is described with regard to FIGS. 1A-1E.

FIGS. 2A-2B are diagrams illustrating an example 200 of training and using a machine learning model in connection with determining performance targets. The machine learning model training described herein may be performed using a machine learning system. The machine learning system may include or may be included in a computing device, a server, a cloud computing environment, or the like, such as the model system described in more detail below.

As shown in FIG. 2A and by reference number 205, a machine learning model may be trained using a set of observations. The set of observations may be obtained and/or input from training data (e.g., historical data), such as data gathered during one or more processes described herein. For example, the set of observations may include data gathered from the historical database and/or the progress database, as described elsewhere herein. In some implementations, the machine learning system may receive the set of observations (e.g., as input) from the administrator device.

As shown by reference number 210, a feature set may be derived from the set of observations. The feature set may include a set of variables. A variable may be referred to as a feature. A specific observation may include a set of variable values corresponding to the set of variables. A set of variable values may be specific to an observation. In some cases, different observations may be associated with different sets of variable values, sometimes referred to as feature values. In some implementations, the machine learning system may determine variables for a set of observations and/or variable values for a specific observation based on input received from the administrator device. For example, the machine learning system may identify a feature set (e.g., one or more features and/or corresponding feature values) from structured data input to the machine learning system, such as by extracting data from a particular column of a table, extracting data from a particular field of a form and/or a message, and/or extracting data received in a structured data format. Additionally, or alternatively, the machine learning system may receive input from an operator to determine features and/or feature values. In some implementations, the machine learning system may perform natural language processing and/or another feature identification technique to extract features (e.g., variables) and/or feature values (e.g., variable values) from text (e.g., unstructured data) input to the machine learning system, such as by identifying keywords and/or values associated with those keywords from the text.

As an example, a feature set for a set of observations may include a first feature of a category, a second feature of a region, a third feature of a past performance, and so on. As shown, for a first observation, the first feature may have a value of Notebooks, the second feature may have a value of Americas, the third feature may have a value of $1.8 million, and so on. These features and feature values are provided as examples, and may differ in other examples. For example, the feature set may include one or more of the following features: a product line, a product, a manager, a team, and/or a teammate, among other examples. In some implementations, the machine learning system may pre-process and/or perform dimensionality reduction to reduce the feature set and/or combine features of the feature set to a minimum feature set. A machine learning model may be trained on the minimum feature set, thereby conserving resources of the machine learning system (e.g., processing resources and/or memory resources) used to train the machine learning model.

As shown by reference number 215, the set of observations may be associated with a target variable. The target variable may represent a variable having a numeric value (e.g., an integer value or a floating point value), may represent a variable having a numeric value that falls within a range of values or has some discrete possible values, may represent a variable that is selectable from one of multiple options (e.g., one of multiples classes, classifications, or labels), or may represent a variable having a Boolean value (e.g., 0 or 1, True or False, Yes or No), among other examples. A target variable may be associated with a target variable value, and a target variable value may be specific to an observation. In some cases, different observations may be associated with different target variable values. In example 200, the target variable is a performance target, which has a value of $1.7 million for the first observation.

The feature set and target variable described above are provided as examples, and other examples may differ from what is described above. For example, the target variable may include a likelihood whether the performance target will be met.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model or a predictive model. When the target variable is associated with continuous target variable values (e.g., a range of numbers), the machine learning model may employ a regression technique. When the target variable is associated with categorical target variable values (e.g., classes or labels), the machine learning model may employ a classification technique.

In some implementations, the machine learning model may be trained on a set of observations that do not include a target variable (or that include a target variable, but the machine learning model is not being executed to predict the target variable). This may be referred to as an unsupervised learning model, an automated data analysis model, or an automated signal extraction model. In this case, the machine learning model may learn patterns from the set of observations without labeling or supervision, and may provide output that indicates such patterns, such as by using clustering and/or association to identify related groups of items within the set of observations.

As further shown, the machine learning system may partition the set of observations into a training set 220 that may include a first subset of observations, of the set of observations, and a test set 225 that may include a second subset of observations of the set of observations. The training set 220 may be used to train (e.g., fit or tune) the machine learning model, while the test set 225 may be used to evaluate a machine learning model that is trained using the training set 220. For example, for supervised learning, the test set 225 may be used for initial model training using the first subset of observations, and the test set 225 may be used to test whether the trained model accurately predicts target variables in the second subset of observations. In some implementations, the machine learning system may partition the set of observations into the training set 220 and the test set 225 by including a first portion or a first percentage of the set of observations in the training set 220 (e.g., 75%, 80%, or 85%, among other examples) and including a second portion or a second percentage of the set of observations in the test set 225 (e.g., 25%, 20%, or 15%, among other examples). In some implementations, the machine learning system may randomly select observations to be included in the training set 220 and/or the test set 225.

As shown by reference number 230, the machine learning system may train a machine learning model using the training set 220. This training may include executing, by the machine learning system, a machine learning algorithm to determine a set of model parameters based on the training set 220. In some implementations, the machine learning algorithm may include a regression algorithm (e.g., linear regression or logistic regression), which may include a regularized regression algorithm (e.g., Lasso regression, Ridge regression, or Elastic-Net regression). Additionally, or alternatively, the machine learning algorithm may include a decision tree algorithm, which may include a tree ensemble algorithm (e.g., generated using bagging and/or boosting), a random forest algorithm, or a boosted trees algorithm. A model parameter may include an attribute of a machine learning model that is learned from data input into the model (e.g., the training set 220). For example, for a regression algorithm, a model parameter may include a regression coefficient (e.g., a weight). For a decision tree algorithm, a model parameter may include a decision tree split location, as an example.

As shown by reference number 235, the machine learning system may use one or more hyperparameter sets 240 to tune the machine learning model. A hyperparameter may include a structural parameter that controls execution of a machine learning algorithm by the machine learning system, such as a constraint applied to the machine learning algorithm. Unlike a model parameter, a hyperparameter is not learned from data input into the model. An example hyperparameter for a regularized regression algorithm may include a strength (e.g., a weight) of a penalty applied to a regression coefficient to mitigate overfitting of the machine learning model to the training set 220. The penalty may be applied based on a size of a coefficient value (e.g., for Lasso regression, such as to penalize large coefficient values), may be applied based on a squared size of a coefficient value (e.g., for Ridge regression, such as to penalize large squared coefficient values), may be applied based on a ratio of the size and the squared size (e.g., for Elastic-Net regression), and/or may be applied by setting one or more feature values to zero (e.g., for automatic feature selection). Example hyperparameters for a decision tree algorithm include a tree ensemble technique to be applied (e.g., bagging, boosting, a random forest algorithm, and/or a boosted trees algorithm), a number of features to evaluate, a number of observations to use, a maximum depth of each decision tree (e.g., a number of branches permitted for the decision tree), or a number of decision trees to include in a random forest algorithm.

To train a machine learning model, the machine learning system may identify a set of machine learning algorithms to be trained (e.g., based on operator input that identifies the one or more machine learning algorithms and/or based on random selection of a set of machine learning algorithms), and may train the set of machine learning algorithms (e.g., independently for each machine learning algorithm in the set) using the training set 220. The machine learning system may tune each machine learning algorithm using one or more hyperparameter sets 240 (e.g., based on operator input that identifies hyperparameter sets 240 to be used and/or based on randomly generating hyperparameter values). The machine learning system may train a particular machine learning model using a specific machine learning algorithm and a corresponding hyperparameter set 240. In some implementations, the machine learning system may train multiple machine learning models to generate a set of model parameters for each machine learning model, where each machine learning model corresponds to a different combination of a machine learning algorithm and a hyperparameter set 240 for that machine learning algorithm.

In some implementations, the machine learning system may perform cross-validation when training a machine learning model. Cross validation can be used to obtain a reliable estimate of machine learning model performance using only the training set 220, and without using the test set 225, such as by splitting the training set 220 into a number of groups (e.g., based on operator input that identifies the number of groups and/or based on randomly selecting a number of groups) and using those groups to estimate model performance. For example, using k-fold cross-validation, observations in the training set 220 may be split into k groups (e.g., in order or at random). For a training procedure, one group may be marked as a hold-out group, and the remaining groups may be marked as training groups. For the training procedure, the machine learning system may train a machine learning model on the training groups and then test the machine learning model on the hold-out group to generate a cross-validation score. The machine learning system may repeat this training procedure using different hold-out groups and different test groups to generate a cross-validation score for each training procedure. In some implementations, the machine learning system may independently train the machine learning model k times, with each individual group being used as a hold-out group once and being used as a training group k-1 times. The machine learning system may combine the cross-validation scores for each training procedure to generate an overall cross-validation score for the machine learning model. The overall cross-validation score may include, for example, an average cross-validation score (e.g., across all training procedures), a standard deviation across cross-validation scores, or a standard error across cross-validation scores.

In some implementations, the machine learning system may perform cross-validation when training a machine learning model by splitting the training set into a number of groups (e.g., based on operator input that identifies the number of groups and/or based on randomly selecting a number of groups). The machine learning system may perform multiple training procedures and may generate a cross-validation score for each training procedure. The machine learning system may generate an overall cross-validation score for each hyperparameter set 240 associated with a particular machine learning algorithm. The machine learning system may compare the overall cross-validation scores for different hyperparameter sets 240 associated with the particular machine learning algorithm, and may select the hyperparameter set 240 with the best (e.g., highest accuracy, lowest error, or closest to a desired threshold) overall cross-validation score for training the machine learning model. The machine learning system may then train the machine learning model using the selected hyperparameter set 240, without cross-validation (e.g., using all of data in the training set 220 without any hold-out groups), to generate a single machine learning model for a particular machine learning algorithm. The machine learning system may then test this machine learning model using the test set 225 to generate a performance score, such as a mean squared error (e.g., for regression), a mean absolute error (e.g., for regression), or an area under receiver operating characteristic curve (e.g., for classification). If the machine learning model performs adequately (e.g., with a performance score that satisfies a threshold), then the machine learning system may store that machine learning model as a trained machine learning model 245 to be used to analyze new observations, as described below in connection with FIG. 3.

In some implementations, the machine learning system may perform cross-validation, as described above, for multiple machine learning algorithms (e.g., independently), such as a regularized regression algorithm, different types of regularized regression algorithms, a decision tree algorithm, or different types of decision tree algorithms. Based on performing cross-validation for multiple machine learning algorithms, the machine learning system may generate multiple machine learning models, where each machine learning model has the best overall cross-validation score for a corresponding machine learning algorithm. The machine learning system may then train each machine learning model using the entire training set 220 (e.g., without cross-validation), and may test each machine learning model using the test set 225 to generate a corresponding performance score for each machine learning model. The machine learning model may compare the performance scores for each machine learning model, and may select the machine learning model with the best (e.g., highest accuracy, lowest error, or closest to a desired threshold) performance score as the trained machine learning model 245.

FIG. 2B is a diagram illustrating an example of applying the trained machine learning model 245 to a new observation. As shown by reference number 250, the machine learning system may receive a new observation (or a set of new observations), and may input the new observation to the machine learning model 245. As shown, the new observation may include a first feature of Servers, a second feature of Americas, and the third feature may be missing, and so on, as an example. The machine learning system may apply the trained machine learning model 245 to the new observation to generate an output (e.g., a result). The type of output may depend on the type of machine learning model and/or the type of machine learning task being performed. For example, the output may include a predicted (e.g., estimated) value of target variable (e.g., a value within a continuous range of values, a discrete value, a label, a class, or a classification), such as when supervised learning is employed. Additionally, or alternatively, the output may include information that identifies a cluster to which the new observation belongs and/or information that indicates a degree of similarity between the new observation and one or more prior observations (e.g., which may have previously been new observations input to the machine learning model and/or observations used to train the machine learning model), such as when unsupervised learning is employed.

In some implementations, the trained machine learning model 245 may predict a value of $5.9 million for the target variable of a performance target for the new observation, as shown by reference number 255. Based on this prediction (e.g., based on the value having a particular label or classification or based on the value satisfying or failing to satisfy a threshold), the machine learning system may provide a recommendation and/or output for determination of a recommendation, such as a recommendation of setting the performance target to $5.9 million. Additionally, or alternatively, the machine learning system may perform an automated action and/or may cause an automated action to be performed (e.g., by instructing another device to perform the automated action), such as setting the performance target to $5.9 million. As another example, if the machine learning system were to predict a value of $4.0 million for the target variable of a performance target, then the machine learning system may provide a different recommendation (e.g., a recommendation of setting the performance target to $4.0 million) and/or may perform or cause performance of a different automated action (e.g., setting the performance target to $4.0 million). In some implementations, the recommendation and/or the automated action may be based on the target variable value having a particular label (e.g., classification or categorization) and/or may be based on whether the target variable value satisfies one or more threshold (e.g., whether the target variable value is greater than a threshold, is less than a threshold, is equal to a threshold, or falls within a range of threshold values).

In some implementations, the trained machine learning model 245 may classify (e.g., cluster) the new observation in a cluster, as shown by reference number 260. The observations within a cluster may have a threshold degree of similarity. As an example, if the machine learning system classifies the new observation in a first cluster (e.g., associated with performance targets in a range from $3.5 million to $4.0 million), then the machine learning system may provide a first recommendation, such as a recommendation to set the performance target between $3.5 million and $4.0 million. Additionally, or alternatively, the machine learning system may perform a first automated action and/or may cause a first automated action to be performed (e.g., by instructing another device to perform the automated action) based on classifying the new observation in the first cluster, such as setting the performance target to a value between $3.5 million and $4.0 million. As another example, if the machine learning system were to classify the new observation in a second cluster (e.g., associated with performance targets in a range from $1.2 million to $1.7 million), then the machine learning system may provide a second (e.g., different) recommendation (e.g., a recommendation to set the performance target between $1.2 million and $1.7 million) and/or may perform or cause performance of a second (e.g., different) automated action, such as setting the performance target to a value between $1.2 million and $1.7 million.

In this way, the machine learning system may apply a rigorous and automated process to setting performance targets. The machine learning system may train and deploy a deep learning model (e.g., as described in connection with FIG. 3). Additionally, the machine learning system may train (e.g., using a similar process as described in connection with FIG. 2A) a shallow learning model to predict likelihoods of hitting performance targets. As a result, the machine learning system may conserve computing resources as compared with training and deploying two deep learning models.

As indicated above, FIGS. 2A-2B are provided as an example. Other examples may differ from what is described in connection with FIGS. 2A-2B. For example, the machine learning model may be trained using a different process than what is described in connection with FIG. 2A. Additionally, or alternatively, the machine learning model may employ a different machine learning algorithm than what is described in connection with FIGS. 2A-2B, such as a Bayesian estimation algorithm, a k-nearest neighbor algorithm, an a priori algorithm, a k-means algorithm, a support vector machine algorithm, a neural network algorithm (e.g., a convolutional neural network algorithm), and/or a deep learning algorithm.

FIG. 3 is a diagram of an example 300 associated with a deep learning model, in accordance with the present disclosure. As shown in FIG. 3, a deep learning model 310 may include an input layer 320 that is configured to ingest input data, such as pre-processed (scaled) sub-images that contain a target object for which detection is to be performed. In one example, the input layer 320 may ingest historical data associated with a set of training entities. The input layer 320 may include a plurality of neurons (e.g., neuron 322).

The deep learning model 310 may include a first set of hidden layers 324a and a second set of hidden layers 324b. The first set of hidden layers 324a may include a plurality of neurons (e.g., neuron 326), and the second set of hidden layers 324b may include a plurality of neurons (e.g., neuron 328). In order to conserve computing resources, the same input layer 320 may be shared by both the first set of hidden layers 324a and the second set of hidden layers 324b.

The deep learning model 310 may further include a first output layer 330a and a second output layer 330b. The first output layer 330a may include at least one neuron (e.g., neuron 332), and the second output layer 330b may include at least one neuron (e.g., neuron 334). By using two separate output layers, the deep learning model 310 may reduce latency by providing outputs concurrently.

The deep learning model 310 may therefore be a multi-layer neural network (e.g., a deep neural network (DNN)) of interconnected neurons. In some cases, the deep learning model 310 may include a feed-forward network, in which case there are no feedback connections where outputs of the network are fed back into itself. In some cases, the deep learning model 310 can include a recurrent neural network (RNN), which can have loops that allow information to be carried across nodes while reading in input.

Neurons of the input layer 320 may activate neurons in the first set of hidden layers 324a and neurons in the second set of hidden layers 324b. The neurons in the first set of hidden layers 324a and in the second set of hidden layers 324b may transform the information from the neurons of the input layer 320 by applying activation functions. The information derived from the transformations may be passed to, and activate, additional neurons in the first set of hidden layers 324a and additional neurons in the second set of hidden layers 324b. Example functions include up-sampling, data transformation, and/or any other suitable functions. The output of final neurons in the first set of hidden layers 324a may activate one or more neurons of the first output layer 330a, at which a first output is provided. Additionally, the output of final neurons in the second set of hidden layers 324b may activate one or more neurons of the second output layer 330b, at which a second output is provided. As described herein, the first output may be a baseline goal, and the second output may be a stretch goal.

The deep learning model 310 may include any suitable deep network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. The deep learning model 310 can include any other deep network other than a CNN, such as an autoencoder, a deep belief network (DBN) and/or an RNN, among other examples.

As indicated above, FIG. 3 is provided as an example. Other examples may differ from what is described with regard to FIG. 3.

FIG. 4 is a diagram of an example environment 400 in which systems and/or methods described herein may be implemented. As shown in FIG. 4, environment 400 may include a model system 401, which may include one or more elements of and/or may execute within a cloud computing system 402. The cloud computing system 402 may include one or more elements 403-412, as described in more detail below. As further shown in FIG. 4, environment 400 may include a network 420, one or more user devices 430, a historical database 440, a progress database 450, and/or an administrator device 460. Devices and/or elements of environment 400 may interconnect via wired connections and/or wireless connections.

The cloud computing system 402 may include computing hardware 403, a resource management component 404, a host operating system (OS) 405, and/or one or more virtual computing systems 406. The cloud computing system 402 may execute on, for example, an Amazon Web Services platform, a Microsoft Azure platform, or a Snowflake platform. The resource management component 404 may perform virtualization (e.g., abstraction) of computing hardware 403 to create the one or more virtual computing systems 406. Using virtualization, the resource management component 404 enables a single computing device (e.g., a computer or a server) to operate like multiple computing devices, such as by creating multiple isolated virtual computing systems 406 from computing hardware 403 of the single computing device. In this way, computing hardware 403 can operate more efficiently, with lower power consumption, higher reliability, higher availability, higher utilization, greater flexibility, and lower cost than using separate computing devices.

The computing hardware 403 may include hardware and corresponding resources from one or more computing devices. For example, computing hardware 403 may include hardware from a single computing device (e.g., a single server) or from multiple computing devices (e.g., multiple servers), such as multiple computing devices in one or more data centers. As shown, computing hardware 403 may include one or more processors 407, one or more memories 408, and/or one or more networking components 409. Examples of a processor, a memory, and a networking component (e.g., a communication component) are described elsewhere herein.

The resource management component 404 may include a virtualization application (e.g., executing on hardware, such as computing hardware 403) capable of virtualizing computing hardware 403 to start, stop, and/or manage one or more virtual computing systems 406. For example, the resource management component 404 may include a hypervisor (e.g., a bare-metal or Type 1 hypervisor, a hosted or Type 2 hypervisor, or another type of hypervisor) or a virtual machine monitor, such as when the virtual computing systems 406 are virtual machines 410. Additionally, or alternatively, the resource management component 404 may include a container manager, such as when the virtual computing systems 406 are containers 411. In some implementations, the resource management component 404 executes within and/or in coordination with a host operating system 405.

A virtual computing system 406 may include a virtual environment that enables cloud-based execution of operations and/or processes described herein using computing hardware 403. As shown, a virtual computing system 406 may include a virtual machine 410, a container 411, or a hybrid environment 412 that includes a virtual machine and a container, among other examples. A virtual computing system 406 may execute one or more applications using a file system that includes binary files, software libraries, and/or other resources required to execute applications on a guest operating system (e.g., within the virtual computing system 406) or the host operating system 405.

Although the model system 401 may include one or more elements 403-412 of the cloud computing system 402, may execute within the cloud computing system 402, and/or may be hosted within the cloud computing system 402, in some implementations, the model system 401 may not be cloud-based (e.g., may be implemented outside of a cloud computing system) or may be partially cloud-based. For example, the model system 401 may include one or more devices that are not part of the cloud computing system 402, such as device 500 of FIG. 5, which may include a standalone server or another type of computing device. The model system 401 may perform one or more operations and/or processes described in more detail elsewhere herein.

The network 420 may include one or more wired and/or wireless networks. For example, the network 420 may include a cellular network, a public land mobile network (PLMN), a local area network (LAN), a wide area network (WAN), a private network, the Internet, and/or a combination of these or other types of networks. The network 420 enables communication among the devices of the environment 400.

The user device(s) 430 may include one or more devices capable of receiving, generating, storing, processing, and/or providing information associated with indications and alerts, as described elsewhere herein. The user device(s) 430 may include a communication device and/or a computing device. For example, the user device(s) 430 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device. The user device(s) 430 may communicate with one or more other devices of environment 400, as described elsewhere herein.

The historical database 440 may include one or more devices capable of receiving, generating, storing, processing, and/or providing information associated with historical data, as described elsewhere herein. The historical database 440 may include a communication device and/or a computing device. For example, the historical database 440 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The historical database 440 may communicate with one or more other devices of environment 400, as described elsewhere herein.

The progress database 450 may include one or more devices capable of receiving, generating, storing, processing, and/or providing information associated with progress data, as described elsewhere herein. The progress database 450 may include a communication device and/or a computing device. For example, the progress database 450 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The progress database 450 may communicate with one or more other devices of environment 400, as described elsewhere herein.

The administrator device 460 may include one or more devices capable of receiving, generating, storing, processing, and/or providing information associated with instructions, as described elsewhere herein. The administrator device 460 may include a communication device and/or a computing device. For example, the administrator device 460 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device. The administrator device 460 may communicate with one or more other devices of environment 400, as described elsewhere herein.

The number and arrangement of devices and networks shown in FIG. 4 are provided as an example. In practice, there may be additional devices and/or networks, fewer devices and/or networks, different devices and/or networks, or differently arranged devices and/or networks than those shown in FIG. 4. Furthermore, two or more devices shown in FIG. 4 may be implemented within a single device, or a single device shown in FIG. 4 may be implemented as multiple, distributed devices. Additionally, or alternatively, a set of devices (e.g., one or more devices) of the environment 400 may perform one or more functions described as being performed by another set of devices of the environment 400.

FIG. 5 is a diagram of example components of a device 500 associated with shallow and deep learning models for determining target likelihoods. The device 500 may correspond to a user device 430, a historical database 440, a progress database 450, and/or an administrator device 460. In some implementations, a user device 430, a historical database 440, a progress database 450, and/or an administrator device 460 may include one or more devices 500 and/or one or more components of the device 500. As shown in FIG. 5, the device 500 may include a bus 510, a processor 520, a memory 530, an input component 540, an output component 550, and/or a communication component 560.

The bus 510 may include one or more components that enable wired and/or wireless communication among the components of the device 500. The bus 510 may couple together two or more components of FIG. 5, such as via operative coupling, communicative coupling, electronic coupling, and/or electric coupling. For example, the bus 510 may include an electrical connection (e.g., a wire, a trace, and/or a lead) and/or a wireless bus. The processor 520 may include a central processing unit, a graphics processing unit, a microprocessor, a controller, a microcontroller, a digital signal processor, a field-programmable gate array, an application-specific integrated circuit, and/or another type of processing component. The processor 520 may be implemented in hardware, firmware, or a combination of hardware and software. In some implementations, the processor 520 may include one or more processors capable of being programmed to perform one or more operations or processes described elsewhere herein.

The memory 530 may include volatile and/or nonvolatile memory. For example, the memory 530 may include random access memory (RAM), read only memory (ROM), a hard disk drive, and/or another type of memory (e.g., a flash memory, a magnetic memory, and/or an optical memory). The memory 530 may include internal memory (e.g., RAM, ROM, or a hard disk drive) and/or removable memory (e.g., removable via a universal serial bus connection). The memory 530 may be a non-transitory computer-readable medium. The memory 530 may store information, one or more instructions, and/or software (e.g., one or more software applications) related to the operation of the device 500. In some implementations, the memory 530 may include one or more memories that are coupled (e.g., communicatively coupled) to one or more processors (e.g., processor 520), such as via the bus 510. Communicative coupling between a processor 520 and a memory 530 may enable the processor 520 to read and/or process information stored in the memory 530 and/or to store information in the memory 530.

The input component 540 may enable the device 500 to receive input, such as user input and/or sensed input. For example, the input component 540 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 550 may enable the device 500 to provide output, such as via a display, a speaker, and/or a light-emitting diode. The communication component 560 may enable the device 500 to communicate with other devices via a wired connection and/or a wireless connection. For example, the communication component 560 may include a receiver, a transmitter, a transceiver, a modem, a network interface card, and/or an antenna.

The device 500 may perform one or more operations or processes described herein. For example, a non-transitory computer-readable medium (e.g., memory 530) may store a set of instructions (e.g., one or more instructions or code) for execution by the processor 520. The processor 520 may execute the set of instructions to perform one or more operations or processes described herein. In some implementations, execution of the set of instructions, by one or more processors 520, causes the one or more processors 520 and/or the device 500 to perform one or more operations or processes described herein. In some implementations, hardwired circuitry may be used instead of or in combination with the instructions to perform one or more operations or processes described herein. Additionally, or alternatively, the processor 520 may be configured to perform one or more operations or processes described herein. Thus, implementations described herein are not limited to any specific combination of hardware circuitry and software.

The number and arrangement of components shown in FIG. 5 are provided as an example. The device 500 may include additional components, fewer components, different components, or differently arranged components than those shown in FIG. 5. Additionally, or alternatively, a set of components (e.g., one or more components) of the device 500 may perform one or more functions described as being performed by another set of components of the device 500.

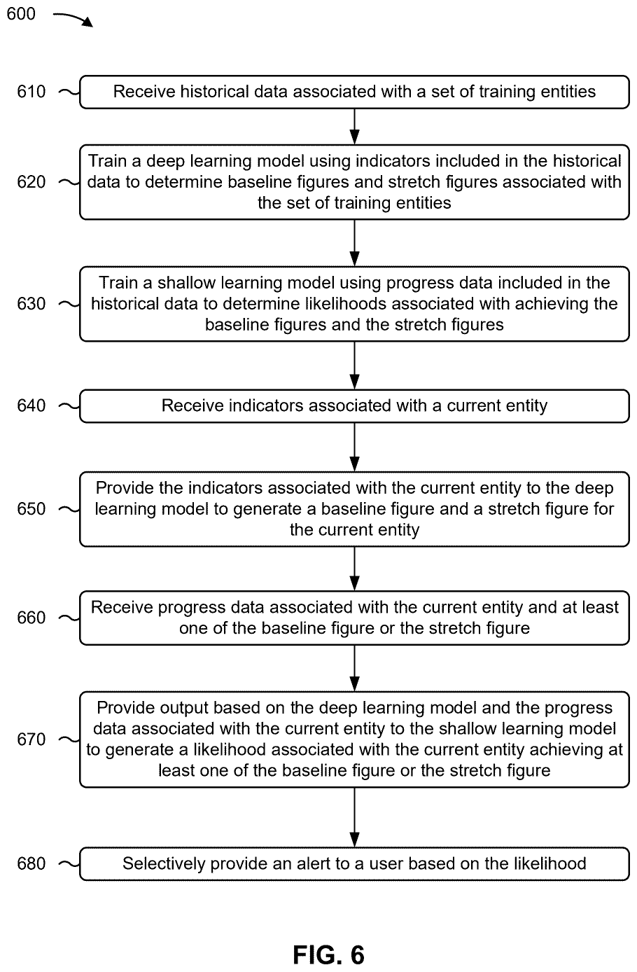

FIG. 6 is a flowchart of an example process 600 associated with using shallow and deep learning models for determining target likelihoods. In some implementations, one or more process blocks of FIG. 6 are performed by a model system (e.g., model system 401). In some implementations, one or more process blocks of FIG. 6 are performed by another device or a group of devices separate from or including the model system, such a user device 430, a historical database 440, a progress database 450, and/or an administrator device 460. Additionally, or alternatively, one or more process blocks of FIG. 6 may be performed by one or more components of device 500, such as processor 520, memory 530, input component 540, output component 550, and/or communication component 560.

As shown in FIG. 6, process 600 may include receiving historical data associated with a set of training entities (block 610). For example, the model system may receive historical data associated with a set of training entities, as described herein.

As further shown in FIG. 6, process 600 may include training the deep learning model using indicators included in the historical data to determine baseline figures and stretch figures associated with the set of training entities (block 620). For example, the model system may train the deep learning model using indicators included in the historical data to determine baseline figures and stretch figures associated with the set of training entities, as described herein.

As further shown in FIG. 6, process 600 may include training the shallow learning model using progress data included in the historical data to determine likelihoods associated with achieving the baseline figures and the stretch figures (block 630). For example, the model system may train the shallow learning model using progress data included in the historical data to determine likelihoods associated with achieving the baseline figures and the stretch figures, as described herein.

As further shown in FIG. 6, process 600 may include receiving indicators associated with a current entity (block 640). For example, the model system may receive indicators associated with a current entity, as described herein.

As further shown in FIG. 6, process 600 may include providing the indicators associated with the current entity to the deep learning model to generate a baseline figure and a stretch figure for the current entity (block 650). For example, the model system may provide the indicators associated with the current entity to the deep learning model to generate a baseline figure and a stretch figure for the current entity, as described herein.

As further shown in FIG. 6, process 600 may include receiving progress data associated with the current entity and at least one of the baseline figure or the stretch figure (block 660). For example, the model system may receive progress data associated with the current entity and at least one of the baseline figure or the stretch figure, as described herein.

As further shown in FIG. 6, process 600 may include providing output based on the deep learning model and the progress data associated with the current entity to the shallow learning model to generate a likelihood associated with the current entity achieving at least one of the baseline figure or the stretch figure (block 670). For example, the model system may provide output based on the deep learning model and the progress data associated with the current entity to the shallow learning model to generate a likelihood associated with the current entity achieving at least one of the baseline figure or the stretch figure, as described herein.

As further shown in FIG. 6, process 600 may include selectively providing an alert to a user based on the likelihood (block 680). For example, the model system may selectively provide an alert to a user based on the likelihood, as described herein.

Process 600 may include additional implementations, such as any single implementation or any combination of implementations described below and/or in connection with one or more other processes described elsewhere herein.

In a first implementation, process 600 includes preprocessing the historical data by normalizing the indicators included in the historical data.

In a second implementation, alone or in combination with the first implementation, process 600 includes applying a feature selection algorithm to identify most predictive indicators from the historical data, where the most predictive indicators are used to train the deep learning model.

In a third implementation, alone or in combination with one or more of the first and second implementations, the deep learning model includes a multi-output model configured to output the baseline figure and stretch figure concurrently.

In a fourth implementation, alone or in combination with one or more of the first through third implementations, the shallow learning model includes a classification model.

In a fifth implementation, alone or in combination with one or more of the first through fourth implementations, selectively providing the alert includes determining that the likelihood satisfies a failure threshold, and transmitting the alert based on the likelihood satisfying the failure threshold.

In a sixth implementation, alone or in combination with one or more of the first through fifth implementations, process 600 includes generating a suggested change for the current entity by varying at least one input to the shallow learning model, where the alert indicates the suggested change.

Although FIG. 6 shows example blocks of process 600, in some implementations, process 600 includes additional blocks, fewer blocks, different blocks, or differently arranged blocks than those depicted in FIG. 6. Additionally, or alternatively, two or more of the blocks of process 600 may be performed in parallel.

The foregoing disclosure provides illustration and description, but is not intended to be exhaustive or to limit the implementations described herein to the precise forms that are described. Modifications and variations may be made in light of the above description or may be acquired from practice of the implementations described herein.

As used herein, the term “component” is intended to be broadly construed as hardware, firmware, and/or a combination of hardware and software. It will be apparent that systems and/or methods described herein may be implemented in different forms of hardware, firmware, or a combination of hardware and software. The actual specialized control hardware or software code used to implement these systems and/or methods is not limiting of the implementations described herein. Thus, the operation and behavior of the systems and/or methods are described herein without reference to specific software code—it being understood that software and hardware can be designed to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or described in the specification, these combinations are not intended to limit the implementations described herein. In fact, many of these features may be combined in ways not specifically recited in the claims and/or described in the specification. Although each dependent claim listed below may directly depend on only one claim, the description includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a component” or “one or more components” (or another element, such as “a processor” or “one or more processors”) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A device for applying a deep learning model and a shallow learning model to determine likelihoods of achieving targets, comprising:
one or more processors configured to:
receive historical data associated with a set of training entities;
train the deep learning model using indicators included in the historical data to determine baseline figures and stretch figures associated with the set of training entities;
train the shallow learning model using progress data included in the historical data to determine likelihoods associated with achieving the baseline figures and the stretch figures;
receive indicators associated with a current entity;
provide the indicators associated with the current entity to the deep learning model to generate a baseline figure and a stretch figure for the current entity;
receive progress data associated with the current entity and at least one of the baseline figure or the stretch figure;
provide output based on the deep learning model and the progress data associated with the current entity to the shallow learning model to generate a likelihood associated with the current entity achieving at least one of the baseline figure or the stretch figure; and
selectively provide an alert to a user based on the likelihood.

2. The device of claim 1, wherein the one or more processors are configured to:
preprocess the historical data by normalizing the indicators included in the historical data.

3. The device of claim 1, wherein the one or more processors are configured to:
apply a feature selection algorithm to identify most predictive indicators from the historical data,
wherein the most predictive indicators are used to train the deep learning model.

4. The device of claim 1, wherein the deep learning model comprises a multi-output model configured to output the baseline figure and stretch figure concurrently.

5. The device of claim 1, wherein the shallow learning model comprises a classification model.

6. The device of claim 1, wherein, to selectively provide the alert, the one or more processors are configured to:
determine that the likelihood satisfies a failure threshold; and
transmit the alert based on the likelihood satisfying the failure threshold.

7. The device of claim 1, wherein the one or more processors are configured to:
generate a suggested change for the current entity by varying at least one input to the shallow learning model,
wherein the alert indicates the suggested change.

8. A method for applying a deep learning model and a shallow learning model to determine likelihoods of achieving targets, comprising:
receiving, by a model system, historical data associated with a set of training entities;
training, by the model system, the deep learning model using indicators included in the historical data to determine baseline figures and stretch figures associated with the set of training entities;
training, by the model system, the shallow learning model using progress data included in the historical data to determine likelihoods associated with achieving the baseline figures and the stretch figures;
receiving, by the model system, indicators associated with a current entity;
providing, by the model system, the indicators associated with the current entity to the deep learning model to generate a baseline figure and a stretch figure for the current entity;
receiving, by the model system, progress data associated with the current entity and at least one of the baseline figure or the stretch figure;
providing, by the model system, output based on the deep learning model and the progress data associated with the current entity to the shallow learning model to generate a
likelihood associated with the current entity achieving at least one of the baseline figure or the stretch figure; and
selectively providing, by the model system, an alert to a user based on the likelihood.

9. The method of claim 8, further comprising:
preprocessing the historical data by normalizing the indicators included in the historical data.

10. The method of claim 8, further comprising:
applying a feature selection algorithm to identify most predictive indicators from the historical data,
wherein the most predictive indicators are used to train the deep learning model.

11. The method of claim 8, wherein the deep learning model comprises a multi-output model configured to output the baseline figure and stretch figure concurrently.

12. The method of claim 8, wherein the shallow learning model comprises a classification model.

13. The method of claim 8, wherein selectively providing the alert comprises:
determining that the likelihood satisfies a failure threshold; and
transmitting the alert based on the likelihood satisfying the failure threshold.

14. The method of claim 8, further comprising:
generating a suggested change for the current entity by varying at least one input to the shallow learning model,
wherein the alert indicates the suggested change.

15. A non-transitory computer-readable medium storing a set of instructions, the set of instructions comprising:
one or more instructions that, when executed by one or more processors of a model system, cause the model system to:
receive historical data associated with a set of training entities;
train a deep learning model using indicators included in the historical data to determine baseline figures and stretch figures associated with the set of training entities;
train a shallow learning model using progress data included in the historical data to determine likelihoods associated with achieving the baseline figures and the stretch figures;
receive indicators associated with a current entity;
provide the indicators associated with the current entity to the deep learning model to generate a baseline figure and a stretch figure for the current entity;
receive progress data associated with the current entity and at least one of the baseline figure or the stretch figure;
provide output based on the deep learning model and the progress data associated with the current entity to the shallow learning model to generate a likelihood associated with the current entity achieving at least one of the baseline figure or the stretch figure; and
selectively provide an alert to a user based on the likelihood.

16. The non-transitory computer-readable medium of claim 15, wherein the one or more instructions cause the model system to:
preprocess the historical data by normalizing the indicators included in the historical data.

17. The non-transitory computer-readable medium of claim 15, wherein the one or more instructions cause the model system to:
apply a feature selection algorithm to identify most predictive indicators from the historical data,
wherein the most predictive indicators are used to train the deep learning model.

18. The non-transitory computer-readable medium of claim 15, wherein the deep learning model comprises a multi-output model configured to output the baseline figure and stretch figure concurrently.

19. The non-transitory computer-readable medium of claim 15, wherein the shallow learning model comprises a classification model.

20. The non-transitory computer-readable medium of claim 15, wherein the one or more instructions cause the model system to:
generate a suggested change for the current entity by varying at least one input to the shallow learning model,
wherein the alert indicates the suggested change.
